(19) United States
(12) Patent Application Publication
(10) Pub. No.: US 2002/0004720 A1
(43) Pub. Date: Jan. 10, 2002

(54) Personal monitoring system

(76) Inventor: Ian Zvonko Janoska, New South Wales (AU)

Correspondence Address: Clifford W. Browning, Woodard, Emhardt, Naughton, Moriarty & McNett, Bank One Center/Tower, 111 Monument Circle, Suite 3700, Indianapolis, IN, 46204, US

(21) Appl. No.: 09/847,492

(22) Filed: May 2, 2001

(30) Foreign Application Priority Data
May 2, 2000 (AU) PQ 7246

(51) Int. Cl. G10L 21/00; G10L 11/00

(52) U.S. Cl. 704/270

(57) ABSTRACT

A system, apparatus and method for personal monitoring of an object are disclosed. The apparatus is associated with the monitored object and comprises one or more acquisition devices for acquiring data relating to the status of the object, a processor for interpreting the data and generating verbal messages and a radio communication device for communicating the verbal message to a user of the system. The system comprises the disclosed apparatus, together with a conventional communications apparatus operable by a user of the system and configurable to receive commnunication of verbal messages from the apparatus and provide an audible representation thereof to the user. Preferred arrangements include monitoring the location of a mobile vehicle and the status of devices such as an alarm system at premises of fixed location. Remote control of functional devices incorporated in the object being monitored, is also possible. Commaands issued by a user are sent via a conventional communication apparatus and may comprise human speech.

### FIELD OF THE INVENTION

The present invention relates to monitoring the location and/or status of an object and, in particular, to the personal monitoring of the location of a vehicle from a location remote from the vehicle.

### BACKGROUND ART

Location and status monitoring systems have been in existence for a good number of years, especially so since the introduction of the GPS satellite system for the provision of positional information. Vehicle monitoring systems provide a user, who is remote from the vehicle, with information regarding the position and status of the vehicle being monitored. Further functionality includes the ability to continuously track the position of a vehicle, within a predefined geographical area, often accompanied by the simultaneous updating of the vehicle's location on a map of the predetermined geographical area.

Traditionally, vehicle monitoring systems have been built around a central database, resident on a central computer, which further incorporated maps of the predetermined geographical area. This has given rise to so-called third party monitoring, where monitoring of a vehicle is performed for a fee and is usually accompanied by a service contract for a specified period of time, Such systems tend to be costly and monitoring of private vehicles is typically only invoked in abnormal circumstances, such as when the vehicle has been reported stolen. However, these available systems become economically justifiable in the case of high value vehicles and particularly so in the case of vehicles transporting valuable cargo. Vehicle monitoring systems also tend to be more available in countries or regions which experience a higher number of instances of vehicle theft.

### SUMMARY OF THE INVENTION

It is an object of the present invention to substantially overcome, or at least ameliorate, one or more deficiencies with existing object monitoring systems. The principles of the present invention address this object through a system whereby a user, remote from an object being monitored, is provided with location and/or status information in respect of the object in a verbal form, thus requiring no further apparatus by the remote user than a landline telephone handset, a mobile telephone handset or a radio transceiver.

In accordance with one aspect of the present invention, there is provided a system for monitoring the location of a mobile object, said system comprising:

(i) apparatus associated with said object, said apparatus comprising:

a position determination device for determining the location of said object;

a processor for interpreting said determined location and generating a verbal message to convey said determined location;

a radio communication device for communication of said verbal message; and

(ii) communications apparatus operable by a user of said system and configurable to receive communication of said verbal message from said apparatus and provide an audible representation thereof to the user.

In accordance with a further aspect of the present invention, there is provided a method of monitoring the location of a mobile object, said method comprising the steps of:

(i) establishing a radio communications link between a user at a location remote from said object, and an apparatus associated with said object;

(ii) determining the location of said object by said apparatus;

(iii) generating a verbal message, by said apparatus, to convey said object location;

(iv) delivering said verbal message by said radio comnnunications link; and

(v) audibly announcing said verbal message to said remote user.

In accordance with a further aspect of the present invention, there is provided an apparatus associated with a mobile object said apparatus comprising:

a position determination device for determining the location of said object; and

a processor for interpreting said determined location and generating a verbal message to convey said determined location.

In accordance with a further aspect of the present invention, there is provided a system for monitoring an object, said system comprising:

(i) apparatus associated with said object, said apparatus comprising:

one or more acquisition devices for acquirng data relating to the status of said object;

a processor for interpreting said acquired data and for generating messages;

a speech processor for converting said generated messages to verbal messages;

a radio communication device for communication of said verbal messages; and

(ii) communications apparatus operable by a user of said system and confguable to receive communication of said verbal messages from said apparatus and provide an audible representation thereof to said user.

In accordance with a further aspect of the present invention, there is provided a method for monitoring an object, said method comprising the steps of:

establishing a radio communications link between a user at a location remote from said object, and an apparatus associated with said object;

determining the status of said object by said apparatus;

generating a verbal message, by said apparatus;

delivering said verbal message by said radio communications link; and

audibly announcing said verbal message to said remote user.

In accordance with a further aspect of the present invention, there is provided an apparatus associated with an object, said apparatus comprising:

one or more acquisition devices for acquiring data relating to the status of said object;

a processor for interpreting said acquired data and for generating messages;

a speech processor for converting said generated messages to verbal messages; and

a radio communication device for communication of said verbal messages.

### BRIEF DESCRIPTION OF THE DRAWINGS

At least one embodiment of the present invention will now be described with reference to the accompanying drawings in which:

FIG. 1 is a schematic diagram representation of a vehicle monitoring system;

FIG. 2 is a schematic block diagram representation of a first arrangement of the mobile monitoring module of FIG. 1;

FIG. 3 is a schematic block diagram representation of the main control unit of Fig, 2;

FIG. 4 is a schematic block diagram representation of a second arrangement of the mobile monitoring module of Fig, 1;

FIG. 5 is a schematic diagram representation of a stationary monitoring system;

FIG. 6 is a schematic block diagram representation of a first arrangement of the monitoring module of FIG. 5;

FIG. 7 is a schematic block diagram representation of the main control unit of FIG. 6; and

FIG. 8 is a schematic block diagram representation of a second arrangement of the monitoring module of Fig. 5.

### DETAILED DESCRIPTION INCLUDING BEST MODE

A first arrangement described relates to a personal monitoring system, having a module arranged within a motor vehicle to be monitored, for providing a user, remote from said vehicle, with audible information concerning location and status of the vehicle. Vehicle location information is acquired by a Global Positioning System (GPS) receiver arranged in the module that utilize signals derived from a number of GPS satellites in space and orbiting the earth. Vehicle status information is acquired by the module directly from the vehicle being monitored. The vehicle status information typically includes one or more of speed, distance travelled, engine revolutions, engine temperature and quantity of fuel remaining. Furthermore, the vehicle monitoring system can also provide the remote user with the ability to exercise a degree of control over the vehicle. Such control includes the remote locking and unlocking of doors of the vehicle, sounding the horn of the vehicle, and immobilisation and de-immobilisation of said vehicle. Control of the vehicle and access to location and status information of the vehicle may be restricted by the requirement of one or more Personal Identification Code (PIN code) entries by said remote user.

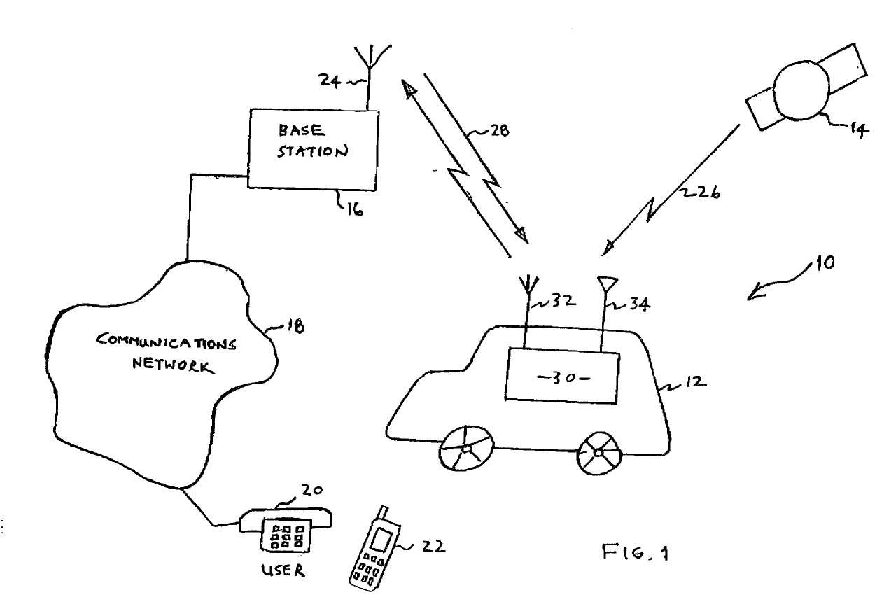

FIG. 1 shows a vehicle monitoring system 10 that enables a user, in possession of a communication device such as a landline telephone handset 20 or a mobile telephone handset 22, to monitor a motor vehicle 12 in which a monitoring module 30 is configured. The module 30 incorporates a GPS receiver antenna 34 for receiving CYPS signals 26 from one or more orbiting GPS satellites 14. The module 30 also incorporates a radio frequency antenna 32 for receiving and transmitting radio frequency signals 28 via a similar antenna 24 forming part of a base station 16. The base station 16 is coupled to a communications network 18 to which the handsets 20 and 22 form a part thereof thereby enabling tbe user to communicate with the module 30 for monitoring purposes.

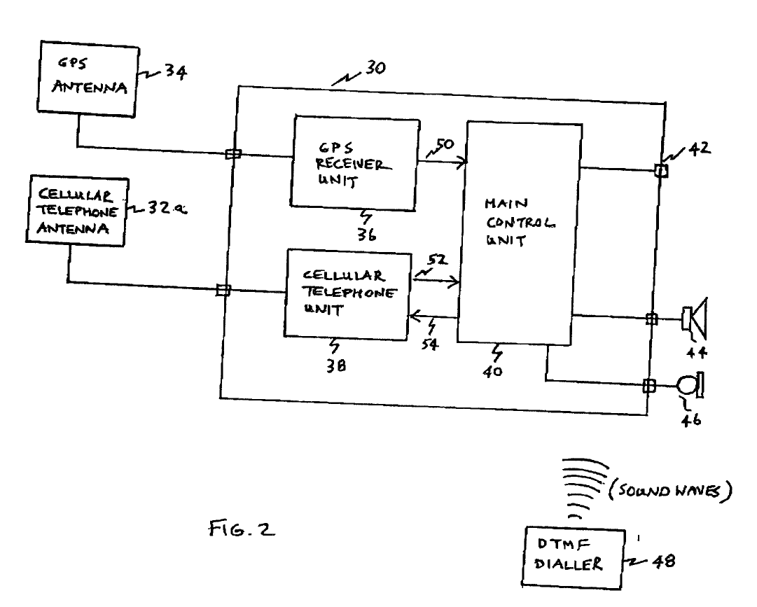

FIG. 2 shows a first arrangement of the module 30 for use where the base station 16 is a cellular base station in a mobile telephone network. Such a network may use one of a number of communication standards such as GSM or CDMA.

The module 30 is installed within the motor vehicle 12 preferably in a covert manner such that the presence of the module 30 is not obvious to a person seated within, or looking into, the motor vehicle 12. The module 30 includes a Global Positioning System (GPS) receiver unit 36, which receives GPS signals from the antenna 34 and outputs GPS position information 50 to a main control unit 40. The GPS receiver unit 36 can incorporate means for differentially correcting GPS position information, and thus supply differentially corrected GPS (DGPS) information to the main control unit 40. The module 30 also includes a cellular telephone unit 38 corresponding in function to those found in cellular handsets, such as the handset 22. The unit 38 connects to the antenna 32a for radio frequency communication with the base station 16 and provides an automated means of origination and reception of telephone calls, outputting audio signals 52 to the main control unit 40 and receiving signals 54 from the main control unit 40 for transmission.

The main control unit 40 receives the GPS position information 50 and operates to provide position details or telephone audio for output via a loudspeaker 44 or via the cellular unit 38 using the connection 54. A microphone 46 enables a person within the motor vehicle 12 to utilize the cellular telephone unit 38 as a traditional mobile telephone, this being facilitated through the provision of a hand-held DTMF dialler device 48, known in the arts FIG. 2 also shows an interface 42 by which the control unit 40 may be coupled to one or more systems of the motor vehicle 12 for control or monitoring, as will be described.

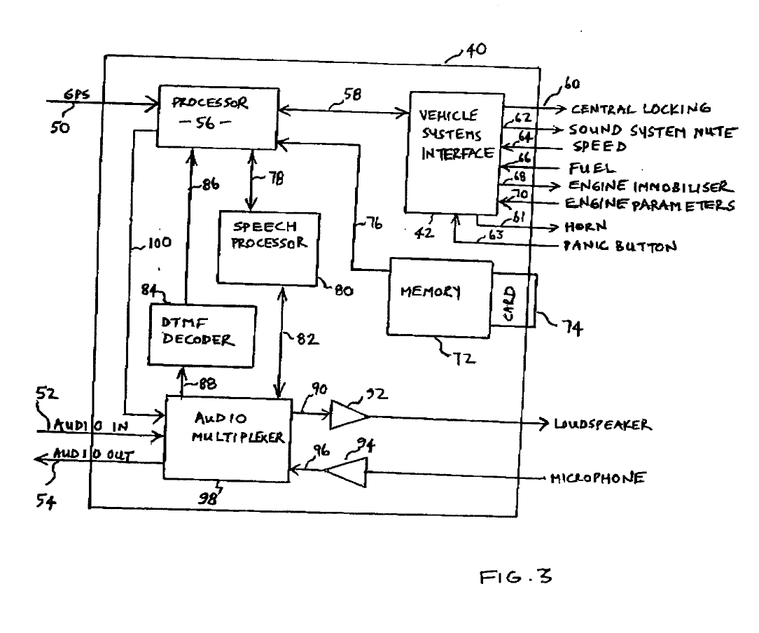

FIG. 3 shows a more detailed view of the main control unit 40 contained within the module 30. The main control unit 40 includes a memory 72 which provides a means of storing an information database containing digitally coded messages of names of streets, suburbs and places for audio reproduction to a user, as will be later described.

Other types of information may also be stored in the memory 72. The memory 72 may be formed either in whole or in part by a removable memory card 74, such as a smartcard or PCMCIA card, which may facilitate numerous different information databases containing information specific to a particular geographical area or to a particular language translation. A processor 56 is configured to access digitally coded messages 76 stored in memory 72 and forward these messages via a connection 78 to a speech processor 80.

The speech processor 80 converts the digitally coded message to an audio signal which is routed to an audio multiplexer 98 by a connection 82. The audio multiplexer 98, under control of the processor 56 by means of control line 100, routes the audio signal from the speech processor 80 either to the cellular telephone unit 38 via audio output line 54 or to the loudspeaker 44, in which case the low level audio signal 90 is amplified by amplifier 92.

As mentioned above, use of the cellular telephone unit 38 as a traditional mobile telephone is facilitated through the provisional of a hand-held DTMF dialler device 48 which, when operated, couples acoustically to the microphone 46. Audio signals captured by microphone 46 are amplified by an amplifier 94 and routed to the audio multiplexer via connection 96 for forwarding to cellular telephone unit 38 via audio output path 54.

Using the hand-held DTMF dialler device 48, in a similar manner, an occupant of vehicle 12 is further able to enter instructions, select menu choices or reconfigure the operating parameters of module 30, in this instance, DTMF tones generated by the dialler device 48 are routed by the audio multiplexer 98 to a DTMF decoder 84 via audio path 88. The decoded tones 86 are then fed to the processor 56.

In a similar manner, a user in possession of a communication device such as the landline telephone handset 20 or the mobile telephone handset 22 is able to issue instructions, select menu options or reconfigure the operating parameters of module 30 by similar DTMF tone generation means contained within those handsets 20 or 22. The DTMF audio tones generated in this way are received by cellular telephone unit 38 in a manner previously described. The DTMF audio tones are then routed to the audio multiplexer 98 by means of audio input 52 and passed to the processor 56 via a DTMF decoder 84 in the same manner as DTMF audio tones captured by microphone 46.

An alternative means of issuing commands, selecting menu options or reconfiguring the operating parameters of module 30, by a user in possession of a communication device such as a landline telephone handset 20 or a mobile telephone handset 22 or an occupant within the vehicle 12, is by an audio speech recognition function provided within speech processor 80. Human speech originating from a user is supplied to the audio multiplexer 98 via the connection 52 or 96 and routed via a bi-directional audio connection 82 to the speech recognition arrangement within the speech processor 80. The speech recognition arrangement converts the audio signal 82 to a digital signal 78 for input to the processor 56.

The processor 56 also sends commands to and receives information from vehicle systems interface 42 via bi-directional link 58. In this manner it is possible for a user in possession of a communication device such as a landline telephone handset 20 or a mobile telephone handset 22 to activate central locking 60, mute the sound system 62, immobilise the engine 68 or sound the horn 61 of the vehicle 12. Information may also be obtained in respect of the speed 64, remaining fuel 66 and engine parameters 70 of the vehicle 12.

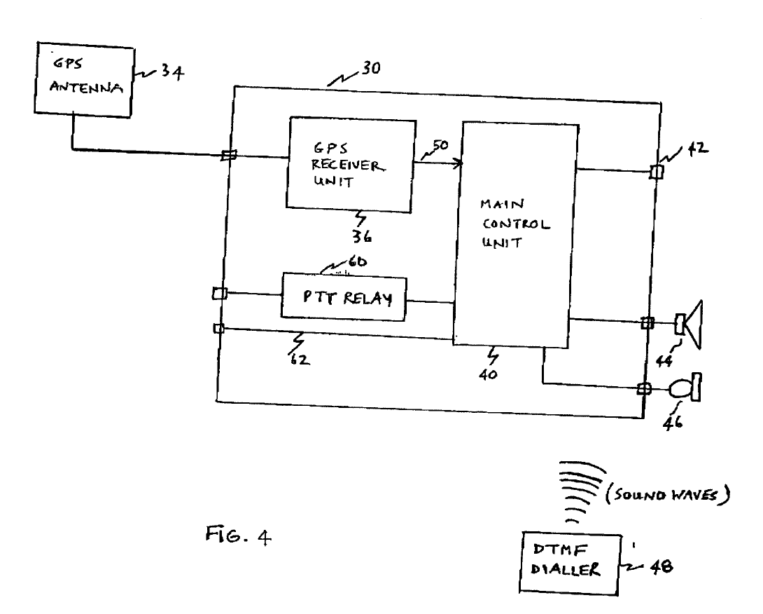

FIG. 4 shows a second arrangement of the module 30 for use where the base station 16 forms part of a private or public radio network, as compared to the telephone network situation of FIG. 2, In FIG. 4, the base station 16 is a first radio transceiver, and the cellular telephone unit 38 of FIG. 3 is replaced by a PTT relay 60 thus permitting use of a second radio transceiver (not shown) which maybe configured external to and separate from module 30. Such a transceiver may be a so-called Citizen Band (CB) radio, or a special VHF or UHF device. The PTT relay 60, under control of the main central unit 40, is used to key the transmitter of the second transceiver (not shown). Audio signals between the second transceiver (not shown) and the main control unit 40 are routed via connection 62. In this second arrangement, the DTMF dialler unit 48 may be employed to enter a PIN code and select menu options.

Substitution of the cellular telephone unit 38 for the PTT relay 60 of FIG. 4 has specific application for objects other than motor vehicles, including marine vessels and transportation containers, and to situations which are not covered by any existing communications networks.

Various modes of operation of the vehicle monitoring system 10 will now be described.

In a first mode of operation of the vehicle monitoring system 10, a user, remote from the vehicle 12, is able to determine the location of the vehicle 12 by the use of a landline telephone handset 20 or a mobile telephone handset 22. The remote user establishes a communications link to the cellular telephone unit 38, located in the vehicle 12, by dialing the pre-assigned number of the cellular telephone unit 38 which is typically stored on a SIMcard (not shown), in the cellular telephone unit 38. The call is automatically answered by the cellular telephone unit 38, under control of the main control unit 40, and the remote user is audibly requested to enter a PIN code for identification purposes, this being facilitated by a data to speech conversion performed by the speech processor 80. The PIN code is validated by the processor 56 and, if successful, the user is audibly presented with a number of menu choices. These choices include a request for location information, engine parameters, fuel remaining or vehicle speed and command instructions to lock/unlock the vehicle, mute the sound system, immobilise the engine or sound the horn. Additional choices include facilitation of a traditional telephone call to any occupant of the vehicle 12 and the modification of operating parameters of the module 30. Certain menu options may only be available upon entry of a higher security level PIN code or a second PIN code. Upon selection, by the remote user, of the vehicle location menu option, the processor 56 acquires the location coordinates of the vehicle 12 fromn the GPS receiver unit 36 and uses the coordinates as an index to acquire a relevant digitally stored street or place name and direction of travel from an appropriate database stored in the memory 72. In this regard, the database may be formed as a lookup table of survey or GPS longitude and latitude coordinates against suburbs or other locals, and street names. The processor 56 is then able to compose a message which is converted to audible form by the speech processor 80 and relayed by the communications network 18 to the remote user. An example of such an audible message might be “Boundary Road, Cherrybrook, heading north-west”. After delivery of a message, the remote user is presented with further menu options until the call is terminated, either by the user or a time-out control by the processor 56. In this fashion, the user is able to monitor the location of the motor vehicle 12 without the need to rely upon a third party monitoring service. The use of speech based reporting via a public telecommunication network affords convenience and ease of operation not offered by prior arrangements. For example, where the user is the owner of the motor vehicle and had earlier parked the motor vehicle, at Parramatta for example, could deduce on receipt of the message “Boundary Road, Cherrybrook” that the motor vehicle had been stolen. The user, with the knowledge of the location of the vehicle, may then sununon the police to assist. Significantly, such a monitoring function may be performed without any interaction with an occupant of the vehicle, or even draw any attention to the monitoring.

In a second mode of operation of the vehicle monitoring system 10, a user, remote from the vehicle 12 is able to determine operating parameters of the vehicle 12 and control certain functions of the sub-systems of vehicle 12. One such situation might be during the actual theft of vehicle 12 whereby a remote user has the ability to imnmobilise the vehicle 12 using the engine immobiliser 68 and lock the doors by operating the central locking 60. A further function might be to sound the horn 60. Any of the functions provided by the audible menu may be selected or activated by a PIN-code validated user in a manmer as described in the first mode of operation.

In a third mode of operation, an occupant within the vehicle 12 is able to make a conventional telephone call, facilitated by the cellular telephone unit 38 and DTMF dialler unit 48. The dialler unit 48 is brought within range of the microphone 46 to enable acoustic coupling. Upon pressing any key of the DTMF dialler unit, the occupant is audibly presented with a menu, as per the previously described modes of operation, by means of loudspeaker 44. PIN code validation may also be required, if so configured in the module 30. Subsequent selection of the telephone call menu option permits the occupant to dial the required telephone number, again facilitated by means of the DTMF dialler unit 48. The occupant can then participate in a conventional telephone conversation, by means of the loudspeaker 44 and microphone 46, until the call is terminated by either party.

In a fourth mode of operation, an occupant of the vehicle 12 is able to determine the location of vehicle 12 for in-car navigation purposes. The audible menu options are accessed by means of the DTMF dialler unit 48, as per the third mode of operation and the location information option is selected and audible message delivered as per the first mode of operation excepting delivery is facilitated via the loudspeaker 44, rather then the communications network 18.

In a fifth mode of operation, the module 30 is configured to detect a change in location of the vehicle 12 and automatically originate a call to a pre-stored telephone number. Alternatively, an occupant of the vehicle 12 may activate a covert “panic button” to activate automatic origination of a call. In this mode of operation, the audible vehicle location information is continuously updated until the remote user terminates the connection. Such operation facilitates tracking of the vehicle 12 in the event that it is stolen.

In a sixth mode of operation, a remote user of the system 10, may talk to the occupants of the motor vehicle 12 using the loudspeaker 44 and microphone 46. Such may be appropriate if, after having determined the location according to the first mode, the user may say “Why are you in Maclay Street, Kings Cross when you told me you were going to a party at Bondi Beach?”

In a seventh mode, control unit 40 may be configured to routinely record locations against real time thereby forming a schedule of vehicle movements. Such a schedule may be periodically uploaded from the vehicle via the communications network for auditing purposes. Such may be useful in fleet management situations.

Each of the various modes of operation may be implemented using one or more computer programs stored within the memory 72, and interpretable for operation by the processor 56 and other components within the control unit 40 and module 30. Such operating programs, or parts thereof may also be stored on the memory card 74 thereby facilitating ease of alteration for upgrade purposes.

It will be apparent that the foregoing describes a system and apparatus that facilitates self-monitoring of remote resources such as motor vehicles. This offers a number of advantages in terms of on-going costs, which are limited to the provision of the cellular phone module and its use, such however is often less expensive than third patty monitoring. Further, many motor vehicles have in-car mounted cellular telephones.

In a further arrangement, the system and apparatus described herein before can be utilised to self-monitor fixed location premises or buildings such as homes and businesses. As a consequence of the monitored object being of fixed location, the use of a GPS receiver unit and antenna are not required.

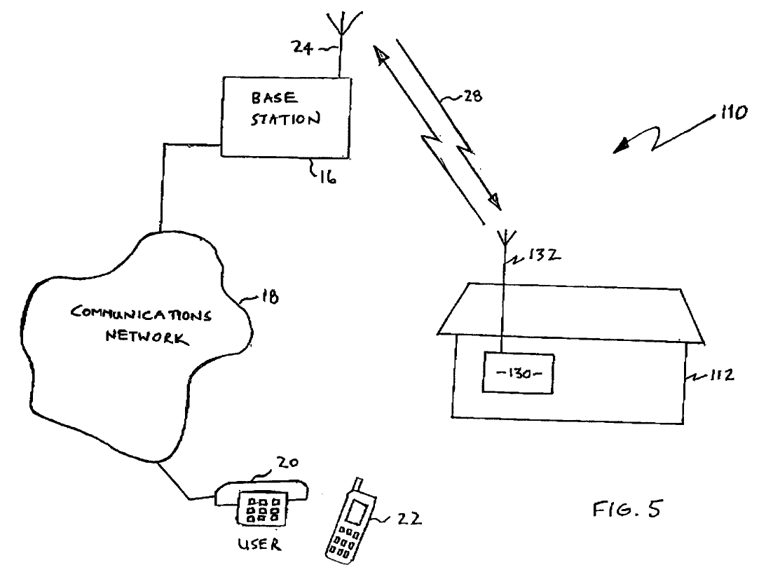

FIG. 5 shows a moitoring system 110 that enables a user, in possession of a communication device such as a landline telephone handset 20 or a mobile telephone handset 22, to monitor premises 112 in which a monitoring module 130 is configured. As can be seen from FIG. 5, GPS receiver antenna 34 is no longer incorporated.

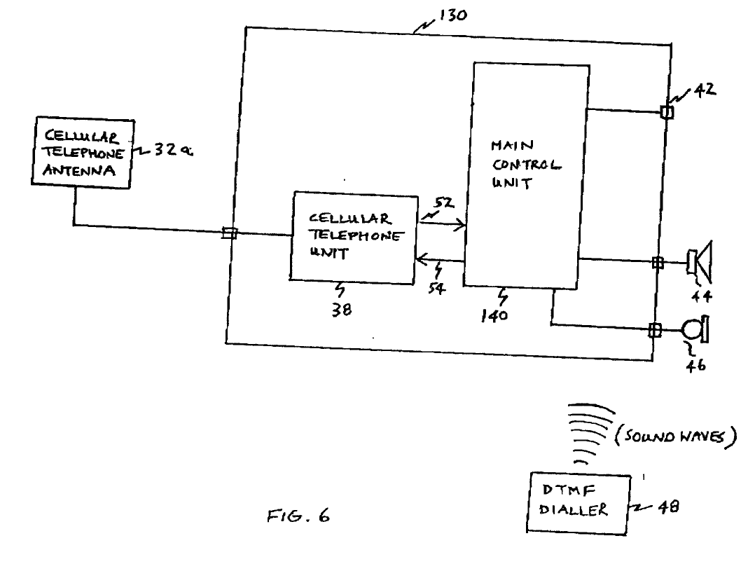

FIG. 6 shows an arrangement of the module 130 for use where the base station 16 is a cellular base station in a mobile telephone network, as earlier described in relation to FIG. 2. The module 130 is installed within the fixed location premises 112, preferably in a covert manner such that the presence of the module 130 is not obvious to a person within fixed location premises 112. The module 130 is substantially similar to the module 30 previously described herein, however, the GPS receiver unit 36 is not incorporated in the module 130.

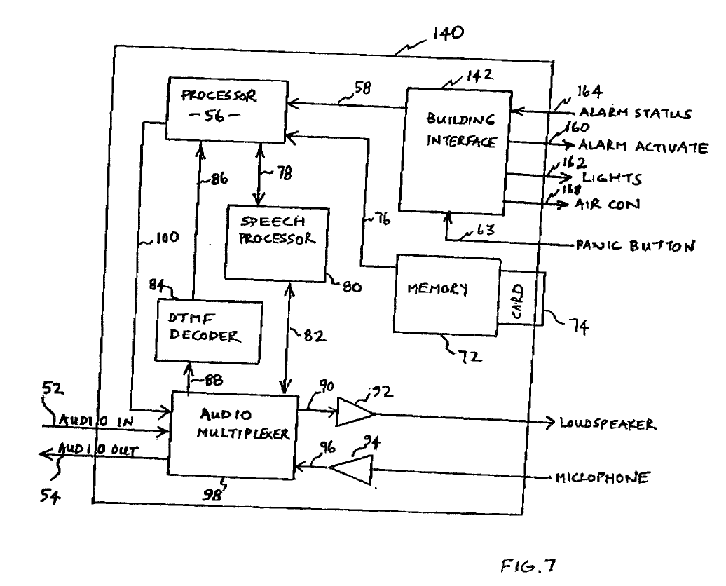

FIG. 7 shows a more detailed view of the main control unit 140 contained within the module 130. As can be seen from FIG. 7, the main control unit 140 is substantially similar to the previously described main control unit 40 depicted in FIG. 3 and the description herein relating to FIG. 3 generally applies to FIG. 7. However, instead of the vehicle system interface 42 that is contained in the main control unit 40, the main control unit 140 (for use with fixed location premises) incorporates a building interface 142. With reference to FIG. 7, it can be seen that the processor 56 sends commands to and receives information from the building interface 142 via the bi-directional link 58. In this manmer it is possible for a user in possession of a communication device such as a landline telephone handset 20 or a mobile telephone handset 22 to perform such functions as activate/de-activate an alarm system 160 and/or turn the lights 162 and air conditioning 168 on or off. Information may also be obtained in respect of the alarm status 164, or in respect of any other sub-systems in fixed location premises 112 that are linked to the main control unit 140 via the building interface 142.

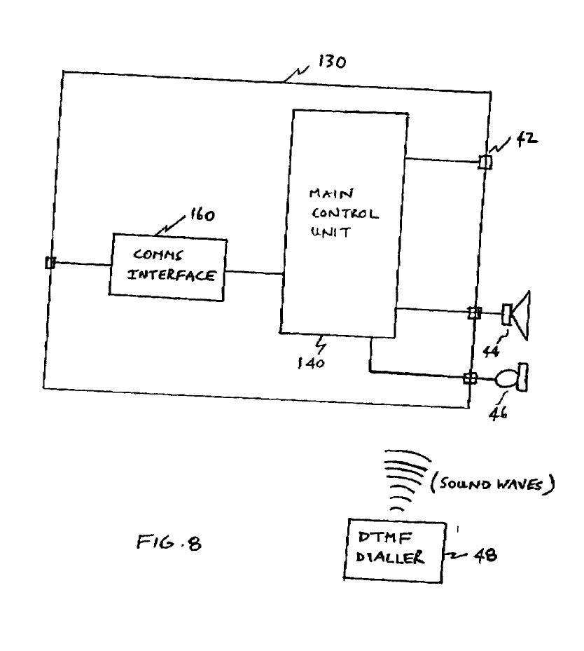

FIG. 8 shows a second arrangement of the module 130 for use where the base station 16 forms part of a private or public network as compared to the telephone network situation of FIG. 6. In FIG. 8, the cellular telephone unit 38 of FIG. 6 is replaced by a communication interface 160, thus enabling use of alternate forms of communications carrier. In one particular arrangement, the communications interface 160 can constitute a PTT relay, such as shown in FIG. 4, thus permitting use of a radio transceiver (not shown) which may be configured external to and separate from the module 130. Alternatively, ibe communications interface 160 may constitute a line interface unit for interfacing the main control unit 140 to the public switched telephone network (landline).

Various modes of operation of the monitoring system 110 are substantially similar to those described herein in relation to the vehicle monitoring system 10. Features previously described, such as PIN code entry for validation purposes, audible presentation of menu choices to user, use of the DTMF dialler unit 48, use of the cellular telephone unit 38 for conventional telephone calls and use of a panic button to activate automatic origination of a call are all within the scope of the monitoring system 110. However, all references to position determination and GPS information should be disregarded as unnecessary for the case of fixed location premises.

In a further mode of operation, the monitoring system 110 enables a remote user to listen in and converse with occupants of the premises being monitored. Such functionality permits the system to be utized as a ‘minder’, in cases where sick or elderly persons have been left alone in the monitored premises. Another application is confirmation of a detected security breach, by audibly monitoring the premises.

The foregoing describes only a few arrangements and modes of operation of the present invention, and modifications and/or changes can be made thereto without departing from the scope and spirit of the invention, the arrangements and modes of operation being illustrative and not restrictive.

I claim:

1. A system for monitoring the location of a mobile object, said system comprising:
(i) mobile apparatus associated with said object, said apparatus comprising:
a position determination device for determining the location of said object;
a processor for interpreting said determined location and generating a verbal message to convey said determined location;
a radio communication device for communicating said verbal message; and
(ii) communications apparatus operable by a user of said system and configurable to receive communication of said verbal message from said apparatus and provide an audible representation thereof to the user.

2. A method of monitoring the location of mobile object, said method comprising the steps of:
(i) establishing a radio communications link between a user at a location remote from said object, and an apparatus associated with said object;
(ii) determining the location of said object by said apparatus;
(iii) generating a verbal message, by said apparatus, to convey said object location;
(iv) delivering said verbal message by said radio communications link; and
(v) audibly announcing said verbal message to said remote user.

3. An apparatus associated with a mobile object, said apparatus comprising:
a position determiation device for determining the location of said object; and
a processor for interpreting said determined location and generating a verbal message to convey said determined location.

4. A system for monitoring an object, said system comprising:
(i) apparatus associated with said object, said apparatus comprising: or more acquisition devices for acquiring data relating to the status of said object;
a processor for interpreting said acquired data and for generating messages;
a speech processor for converting said generated messages to verbal messages;
a radio communication device for communication of said verbal messages; and
(ii) communications apparatus operable by a user of said system and configurable to receive communication of said verbal messages from said apparatus and provide an audible representation thereof to said user.

5. A system as claimed in claim 4, wherein said apparatus associated with said object is configured to automatically generate and communicate a verbal message to a user of said system upon said apparatus detecting a change in the status of said object.

6. A system as claimed in claim 4, wherein said apparatus associated with said object further comprises a decoding device configured to receive and decode command signals of a user, issued via said communications apparatus, in response to a verbal message received by said user.

7. A system as claimed in claim 6, wherein said decoding device is further configured to receive and decode command signals of said user, for controlling at least one functional feature incorporated in said object.

8. A system as claimed in claim 4, wherein said apparatus associated with said object farther comprises a human speech interpretation device for interpreting speech commands of a user, issued via said communications apparatus, in response to a verbal message generated by said apparatus and received by said user.

9. A system as claimed in claim 8, wherein said human speech interpretation device is configured to interpret speech commands of said user, issued via said communications apparatus, for controlling at least one functional feature incorporated in said object.

10. A system as claimed in claim 4, wherein said one or more acquisition devices include a Global Positioning System (GPS) device for determining the geographic location of said object.

11. A system as claimed in claim 10, wherein said apparatus associated with said object further comprises a database for relating position coordinates provided by said GPS device with at least a location name for inclusion in said verbal message.

12. A system as claimed in claim 11, wherein said database comprises street names related to position coordinates, wherein said street names are representative of said location names.

13. A system as claimed in claim 12, wherein said apparatus is configured to monitor a mobile vehicle.

14. A system as claimed in claim 13 wherein said apparatus is further configured to provide verbal navigational information to an occupant of said mobile vehicle.

15. A system as claimed in claim 4, wherein said radio communication device comnprises a cellular telephone device.

16. A system as claimed in claim 4, wherein said communication apparatus comprises a telephone apparatus.

17. A system as claimed in claim 16, wherein said telephone apparatus comprises a cellular mobile telephone apparatus.

18. A system as claimed in claim 4, wherein said apparatus is configured for monitoring premises of fixed location.

19. A method for monitoring an object, said method comprising the steps of:
establishing a radio communications link between a user at a location remote from said object, and an apparatus associated with said object;
determining the status of said object by said apparatus;
generating a verbal message, by said apparatus;
delivering said verbal message by said radio communications link; and
audibly announcing said verbal message to said remote user.

20. A method as claimed in claim 19, wherein said step of establishing said radio communications link is performed by said user.

21. A method as claimed in claim 19, wherein said step of establishing said radio communications link is automatically performed by said apparatus upon detection of a change in status of said object by said apparatus.

22. A method as claimed in claim 19, wherein said step of delivering said verbal message is performed using a cellular radio network.

23. A method as claimed in claim 19, wherein said step of audibly amnnouncing is performed using a telephone apparatus.

24. A method as claimed in claim 19, wherein said step of audibly announcing is performed using a cellular mobile telephone apparatus.

25. A method as claimed in claim 19, wherein said object to be monitored comprises fixed location premises.

26. A method as claimed in claim 19, wherein said method further comprises the step of said user responding, via said communication apparatus, to a verbal message received by said user, via said communication apparatus.

27. A method as claimed in claim 19, wherein said method further comprises the step of said user issuing commands, via said communication apparatus, for remotely controlling at least one functional feature incorporated in said object.

28. A method as claimed in claim 19, wherein said method further comprises the step of said user verbally responding, via said comnunication apparatus, to a verbal message received by said user, via said communication apparatus29.

29. A method as claimed in claim 19, wherein said method further comprises the step of said user verbally issuing commands, via said communication apparatus, for remotely controlling at least one functional feature incorporated in said object.

30. A method as claimed in claim 19, wherein said method further comprises the step of audibly delivering a verbal message to an occupant of said object.

31. An apparatus associated with an object, said apparatus comprising. one or more acquisition devices for acquiring data relating to the status of said object;
a processor for interpreting said acquired data and for generating messages;
a speech processor for converting said generated messages to verbal messages; and
a radio communication device for communication of said verbal messages.

32. An apparatus as claimed in claim 31, wherein said apparatus is configured to automatically generate and communicate a verbal message to a remote user upon said apparatus detecting a change in the status of said object.

33. An apparatus as claimed in claim 31, wherein said apparatus further comprises a decoding device configured to receive and decode command signals received from a remote user, in response to a verbal message generated by said apparatus and received by said user.

34. An apparatus as claimed in claim 33, wherein said decoding device is further configured to receive and decode command signals received from said remote user, for controlling at least one functional feature incorporated in said object.

35. An apparatus as claimed in claim 31, wherein said apparatus farther comprises a human speech interpretation device for interpreting speech commands received from a remote user, in response to a verbal message generated by said apparatus and received by said user.

36. An apparatus as claimed in claim 35, wherein said human speech interpretation device is configured to interpret speech commands of said user, for controlling at least one functional feature incorporated in said object.

37. An apparatus as claimed in claim 31, wherein said one or more acquisition devices include a Global Positioning System (GPS) device for determining the geographic location of said object.

38. An apparatus as claimed in claim 37, further comprising a database for relating position coordinates provided by said GPS device with at least a location name, for inclusion in said verbal message.

39. An apparatus as claimed in claim 38, wherein said database comprises street names related to position coordinates, wherein said street names are representative of said location names.

40. An apparatus as claimed in claim 39, wherein said apparatus is configured to monitor a mobile vehicle.

41. An apparatus as claimed in claim 40, wherein said apparatus is further configured to provide verbal navigational information messages to an occupant of said mobile vehicle.

42. An apparatus as claimed in claim 31, wherein said radio communication device comprises a cellular telephone device.

43. An apparatus as claimed in claim 31, wherein said communication apparatus comprises a telephone apparatus.

44. An apparatus as claimed in claim 43, wherein said telephone apparatus comprises a cellular mobile telephone apparatus.

45. An apparatus as claimed in claim 31, wherein said apparatus is configured for monitoring premises of fixed location.
